(19) United States
(12) Patent Application Publication
(10) Pub. No.: US 2025/0202420 A1
(43) Pub. Date: Jun. 19, 2025

(54) LIGHT DISPERSION DEVICE FOR USE WITH A SOLAR PANEL ASSEMBLY

(71) Applicants: Mark T. Holtzapple, College Station, TX (US); David Carrabba, Bryan, TX (US)

(72) Inventors: Mark T. Holtzapple, College Station, TX (US); David Carrabba, Bryan, TX (US)

(21) Appl. No.: 18/972,592

(22) Filed: Dec. 6, 2024

Related U.S. Application Data
(63) Continuation-in-part of application No. PCT/US23/67907, filed on Jun. 4, 2023.
(60) Provisional application No. 63/349,736, filed on Jun. 7, 2022.

(51) Int. Cl. H02S 40/22; G02B 3/08

(52) U.S. Cl. CPC H02S 40/22; G02B 3/08

(57) ABSTRACT

Some implementations herein relate to a light dispersion device for use with a solar panel assembly. An improved method for a solar structure has been provided. In some implementations, the device may include a transparent or translucent material having a surface configured with a light-diffusing pattern. In addition, the device may include where the light-diffusing pattern is adapted to scatter and redistribute incoming sunlight to enhance illumination beneath the solar panel assembly. The device may include where the light dispersion device is positioned between individual solar panels or attached to the underside of the solar panels.

### CROSS-REFERENCE TO RELATED APPLICATIONS

This application is a continuation-in-part of PCT Application No. PCT/US23/67907 filed on Jun. 4, 2023, entitled “SYSTEMS AND METHODS FOR PROVIDING A SOLAR STRUCTURE,” which claims priority to U.S. patent application Ser. No. 63/349,736 filed on Jun. 7, 2022, entitled “SOLAR STRUCTURE.” These applications are hereby incorporated by reference in its entirety.

### TECHNICAL FIELD

Aspects of the present disclosure relate to solar structures and, in particular, to systems with a light dispersion device for use with a solar panel assembly.

### BACKGROUND

With a virtually unlimited supply of energy from the sun, solar panels show a lot of promise as a renewable energy source. However, a variety of barriers stand in the way of broader adoption of solar panels. While panels themselves are dropping in price, the installation price is still prohibitive.

### SUMMARY

Some implementations herein relate to a light dispersion device for use with a solar panel assembly. In one general aspect, a light dispersion device may include a transparent or translucent material having a surface configured with a light-diffusing pattern. The light dispersion device may also include where the light-diffusing pattern is adapted to scatter and redistribute incoming sunlight to enhance illumination beneath the solar panel assembly. The device may furthermore include where the light dispersion device is positioned between individual solar panels or attached to the underside of the solar panels. Other embodiments of this aspect include corresponding computer systems, apparatus, and computer programs recorded on one or more computer storage devices, each configured to perform the actions of the methods.

Implementations may include one or more of the following features: a light dispersion device where the light-diffusing pattern may include a Fresnel lens formed on the surface of the transparent or translucent material; a light dispersion device where the light-diffusing pattern may include flutes or ribs formed on the surface of the transparent or translucent material, the flutes or ribs being configured to scatter light laterally; a light dispersion device where the light-diffusing pattern may include random surface textures that scatter incoming light in multiple directions; a light dispersion device where the transparent or translucent material is selected from a group consisting of glass, plastic, acrylic, and polycarbonate. Implementations of the described techniques may include hardware, a method or process, or a computer tangible medium.

In one general aspect, a light dispersion device may include a transparent or translucent material having a surface configured to disperse incoming sunlight, where the surface includes one or more light-diffusing patterns that scatter sunlight to enhance illumination in areas below the solar panel assembly. Other embodiments of this aspect include corresponding computer systems, apparatus, and computer programs recorded on one or more computer storage devices, each configured to perform the actions of the methods.

Implementations may include one or more of the following features: a light dispersion device where the light-diffusing pattern may include a Fresnel lens formed on the surface of the transparent or translucent material; a light dispersion device where the light-diffusing pattern may include flutes or ribs formed on the surface of the transparent or translucent material, the flutes or ribs being configured to scatter light laterally; a light dispersion device where the light-diffusing pattern may include random surface textures that scatter incoming light in multiple directions; a light dispersion device where the light-diffusing pattern may include dimples formed on the surface of the transparent or translucent material, the dimples being configured to scatter light by diffraction and reflection; a light dispersion device where the light-diffusing pattern may include a frosted pattern formed on the surface of the transparent or translucent material; a light dispersion device where the frosted pattern is formed by grit blasting the surface of the transparent or translucent material; a light dispersion device where the light-diffusing patterns are formed by casting the transparent or translucent material; a light dispersion device where the light-diffusing patterns are formed by extrusion of the transparent or translucent material; a light dispersion device where the light-diffusing patterns are formed by rolling the transparent or translucent material; a light dispersion device where the transparent or translucent material is selected from a group consisting of glass, plastic, acrylic, and polycarbonate; a light dispersion device where the light dispersion device is integrated as a standalone component or incorporated into an existing structure of the solar panel assembly; a light dispersion device where the light dispersion device further may include a concave or convex lens for focusing and spreading light over a wider area; a light dispersion device where the light-diffusing pattern is configured to enhance light dispersion beneath the solar panel assembly for reducing shaded areas and promoting uniform illumination

### BRIEF DESCRIPTION OF THE DRAWINGS

The various features and advantages of the technology of the present disclosure will be apparent from the following description of particular embodiments of those technologies, as illustrated in the accompanying drawings. It should be noted that the drawings are not drawn to scale; however, the emphasis instead is being placed on illustrating the principles of the technological concepts. Also, in the drawings, the like reference characters refer to the same parts throughout the different views. The drawings depict only typical embodiments of the present disclosure and, therefore, are not to be considered limiting in scope.

FIG. 1 shows the recent historical price of solar panels in the United States.

FIG. 2 shows a side view of a solar pergola, according to an embodiment of the disclosure. FIG. 3a shows how the vertical columns are mounted to the concrete foundation, according to an embodiment of the disclosure.

FIG. 3b shows a similar embodiment to FIG. 3a, except the plate at the bottom is replaced with a lip, which allows the entire center of the column to be open.

FIG. 4 shows a top view of the structure, according to an embodiment of the disclosure.

FIG. 5a shows a detailed connection between the vertical column and the major cross beams, according to an embodiment of the disclosure.

FIG. 5b shows an embodiment in which the welded angle has slots rather than holes, which gives flexibility during assembly.

FIG. 5c shows an embodiment in which the welded angle is held in place by a bolted clamp rather bolted holes or slots, which gives even greater flexibility during assembly.

FIG. 5d shows an embodiment in which the vertical column is too small to have a cleft.

FIG. 6 shows the major cross beam has a welded threaded plate, according to an embodiment of the disclosure.

FIG. 7a shows the right-angle joint that connects the standard solar panel rails to the minor cross beams, according to an embodiment of the disclosure.

FIG. 7b is an embodiment similar to FIG. 7a, except the right-angled joint is welded directly to the minor cross beam

FIG. 8 shows a top view of the pergola in which the major cross beams are spliced together at the joints atop the vertical columns, according to an embodiment of the disclosure.

FIG. 9a shows how the major cross beams are spliced together at the joints atop large vertical columns, according to an embodiment of the disclosure.

FIG. 9b shows how the major cross beams are spliced together at the joints atop small vertical columns, according to an embodiment of the disclosure.

FIG. 10 shows that hollow beams can contain wiring systems, according to an embodiment of the disclosure.

FIG. 11 shows an alternative embodiment where the support columns are moved towards the center.

FIG. 12 shows an overhead view of the covered parking system, according to an embodiment of the disclosure.

FIG. 13a shows a U-shaped clamp for connecting minor cross beams to major cross beams, according to an embodiment of the disclosure.

FIG. 13b shows a U-shaped plate for connecting minor cross beams to major cross beams, according to an embodiment of the disclosure.

FIG. 14 shows pre-assembled structures that can be brought to the job site, which minimizes time for field erection and thereby reduces installation costs.

FIG. 15a shows how a major cross beam is supported by a temporary removable structure, such as a sawhorse.

FIG. 15b shows the minor cross beams installed on the major cross beam.

FIG. 15c shows the installation of the standard solar panel rail.

FIG. 15d shows the solar panels installed on the standard solar panel rail.

FIG. 15e shows a temporary jack installed between the foundation and the major cross beam. The joining system is temporary, such as a removable clamp.

FIG. 15f shows the sawhorses have been removed.

FIG. 15g shows the temporary jack has been extended, which raises the structure.

FIG. 15h shows the other support column has been installed.

FIG. 15i shows the temporary jack has been removed, which completes the installation procedure.

FIG. 16 shows the rate of photosynthesis as a function of light intensity.

FIG. 17 illustrates light dispersion principles from which embodiments of the disclosure may benefit.

FIG. 18A shows a concave shape on both surfaces of a lens.

FIG. 18B, view b, shows a concave shape lens on one surface of a lens.

FIG. 19 shows a concave Fresnel lens installed between the panels, according to an embodiment of the disclosure.

FIG. 20 shows the panels and a concave Fresnel lens installed on the support structure, according to an embodiment of the disclosure.

### DETAILED DESCRIPTION

The figures described below, and the various embodiments used to describe the principles of the present disclosure in this patent document are by way of illustration only and should not be construed in any way to limit the scope of the disclosure. Those skilled in the art will understand that the principles of the present disclosure invention may be implemented in any type of suitably arranged device or system. Additionally, the drawings are not necessarily drawn to scale.

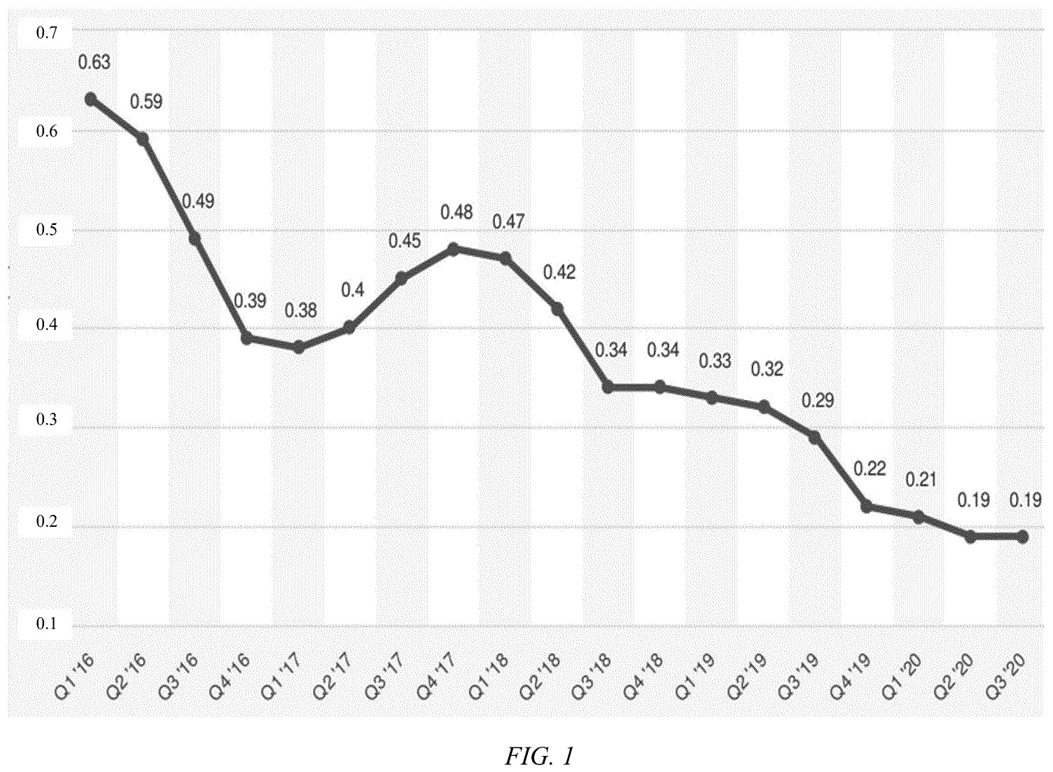

FIG. 1 shows the recent historical price of solar panels in the United States. In 2020, the price was $0.19/Wₚₑₐₖ. As references, the 2013 price was $0.74/Wₚₑₐₖ, and the 1977 price was $76.67/Wₚₑₐₖ. The price has reduced so dramatically that solar power has become economically attractive.

To improve the economics of solar power even further, the cost of the support structures must be reduced. The cost can be reduced substantially by installing factory-built kits that are less costly than field-erected, custom-designed support structures. To be successful, the factory-built kits should have the following properties:
Lightweight
Long lived
Low maintenance
Flexible
Strong
Aesthetically attractive

Furthermore, the installation should have the following properties:
Rapid
Inexpensive
Easy
Safe
Bolted together in the field
No painting required in the field

Although solar panels can be installed on house roofs, the panels are often perceived as unattractive, and thereby detract from property values. In some cases, their installation is banned by homeowner associations. Furthermore, installing solar panels on roofs can be dangerous and time consuming.

To overcome the problems with roof-mounted solar panels, the panels can be erected onto other structures. To lower the effective cost, these structures should have dual-use functions where the cost of the structure can be borne by additional benefits besides providing solar power. The inventions described herein are envisioned for the following dual-use functions:
Pergola—shade for recreation
Parking—shade for automobiles
Agriculture—shade for crops

### Pergola

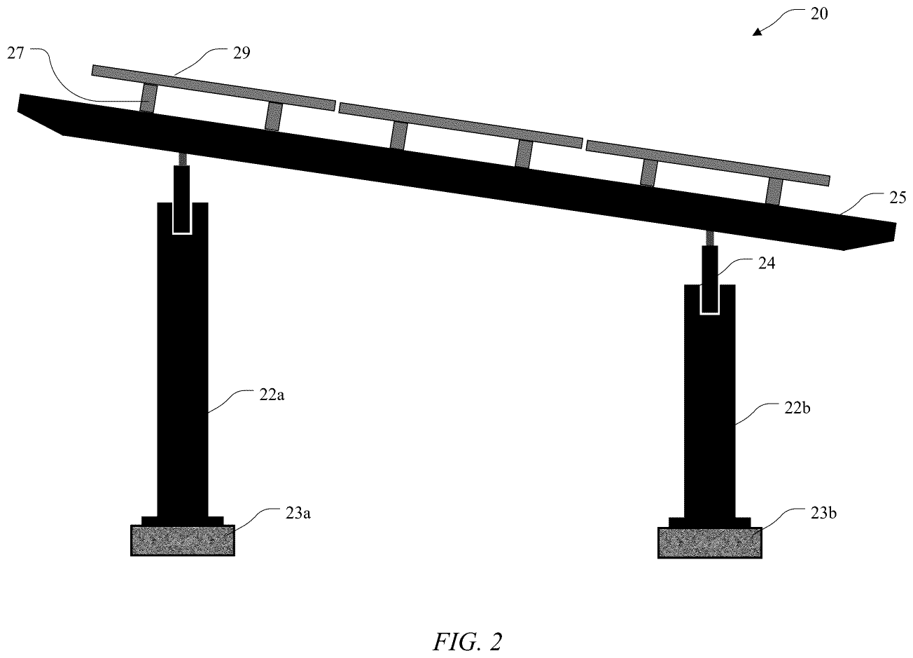

FIG. 2 shows a side view of a solar pergola 20. Vertical columns 22a, 22b are anchored into a concrete foundation 23a, 23b. Major cross beams 24 are sandwiched into a cleft created in the column 22a, 22b, which creates a secure connection. Minor cross beams 25 connect to the major cross beams 24. Mounted to the minor cross beams are standard solar panel rails to which the solar panels are mounted.

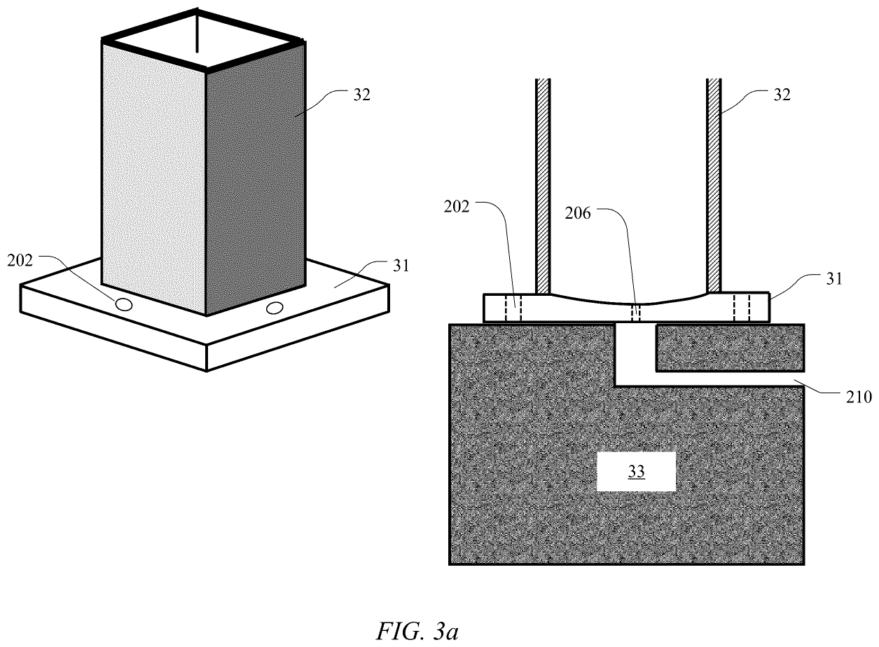

FIG. 3a shows how vertical columns 32 can be mounted to the concrete foundation 33, according to an embodiment of the disclosure. Located at the bottom of the vertical column is a plate 31 that has holes 202. Anchor bolts (not shown) secure the plate to the concrete foundation 33.

The vertical column 32 is hollow and can collect moisture that penetrates through weld imperfections. To avoid internal rusting and potential damage from water expansion caused by freezing accumulated water, a drainage system is incorporated into the vertical column 32. A hole 206 at the bottom of the bolt plate allows water to drain into the concrete foundation, which is equipped with a drainage channel. FIG. 3b shows a similar embodiment, except the plate 31b at the bottom is replaced with a lip, which allows the entire center of the column 32 to be open. Replacing the plate with a lip reduces material costs, reduces transport costs, and makes it easier to install.

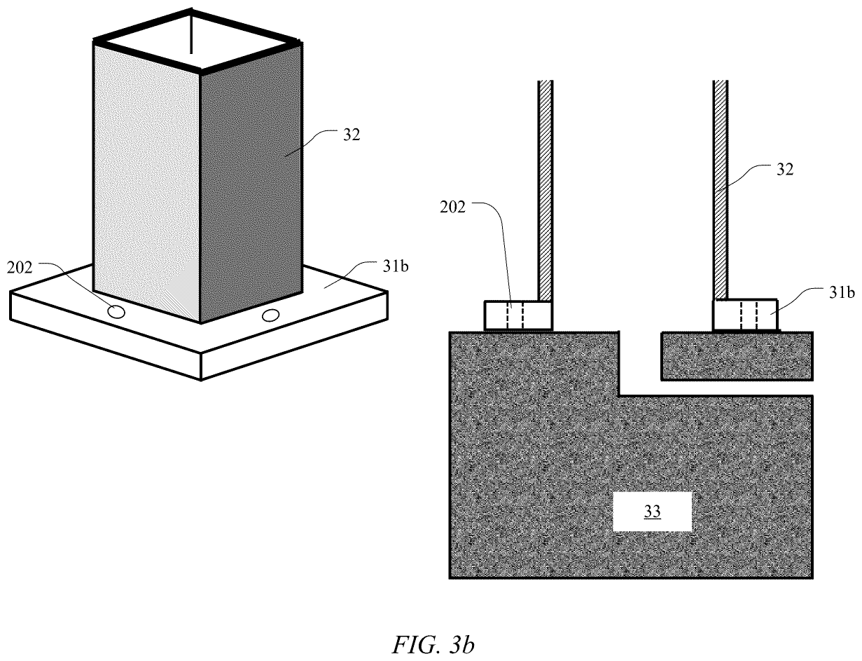

FIG. 4 shows a top view of the structure 40. The vertical columns 42 are shown as open boxes that support the major cross beams. The minor cross beams are supported by the major cross beams 44. The solar panel rails bridge the minor cross beams.

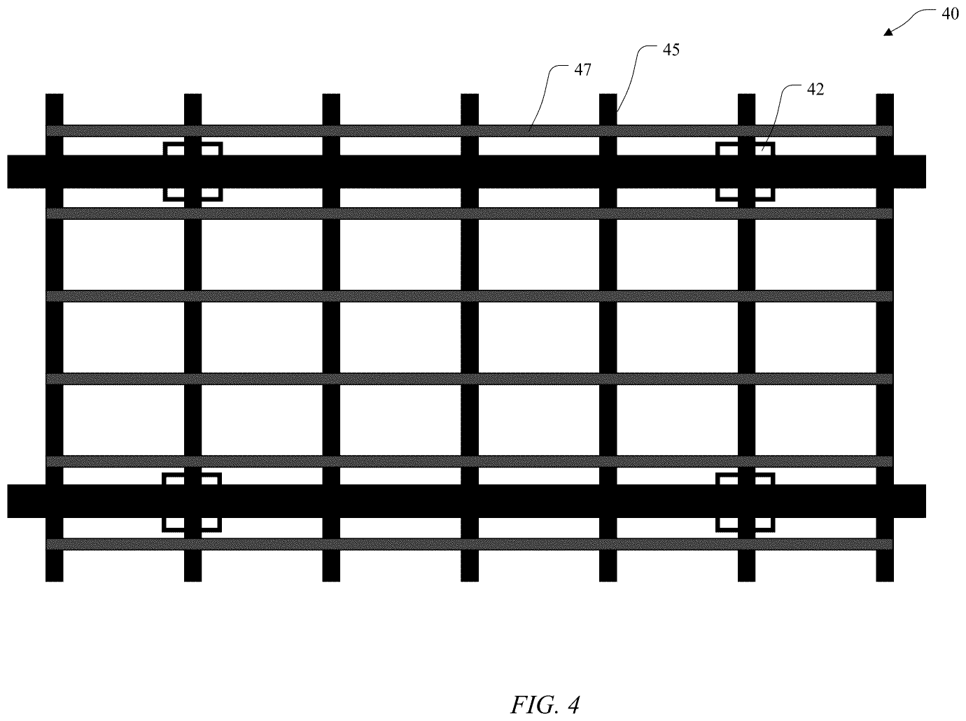

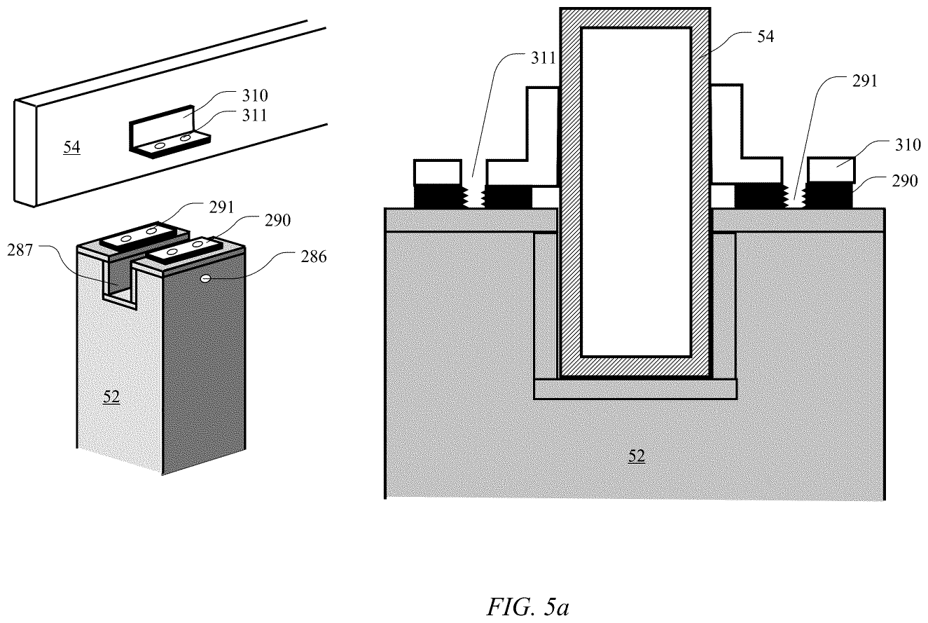

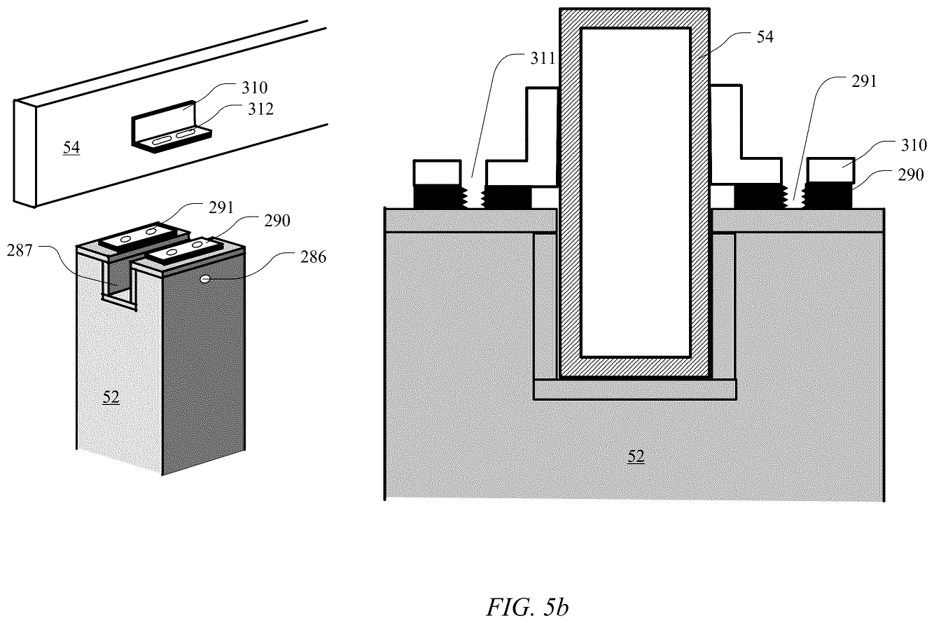

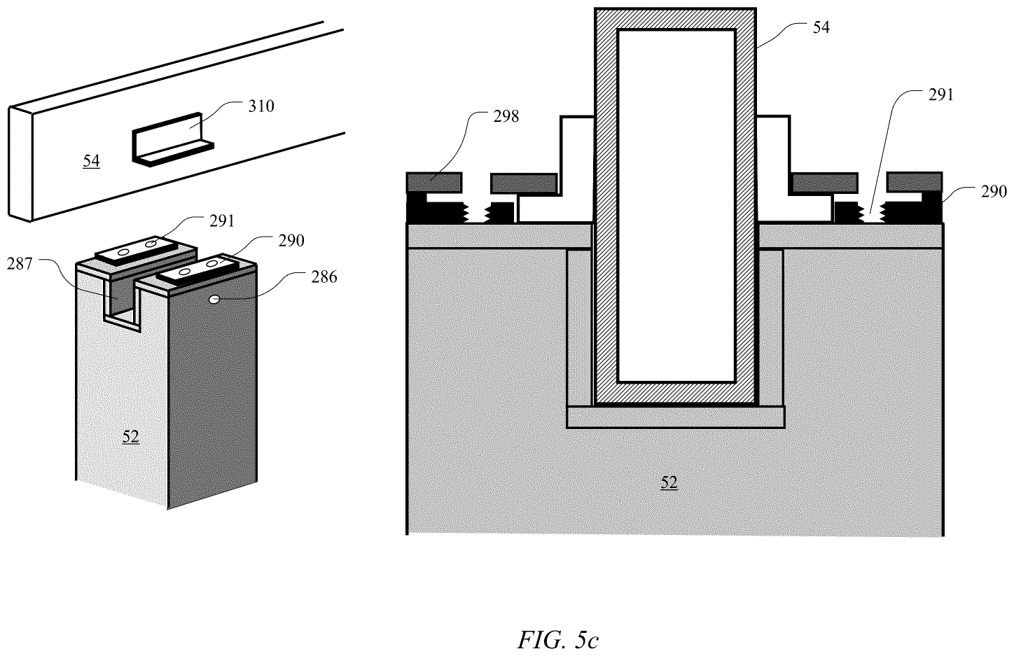

FIG. 5a shows a detailed connection between the vertical column 52 and the major cross beams 4. The top of the column has a welded plate 290 with threaded holes 291. The major cross beam has a welded angle 310 with holes 311 that match the top of the vertical column when it is inserted into the cleft. FIG. 5a shows the vertical column 54 with a square cross-section; however, it could also have a rectangular or circular cross-section.

The cleft 287 allows the major cross beam 54 to be supported by the vertical columns 52 before the bolts are inserted. This feature makes erection both safer and faster, while also contributing to the aesthetics.

A small hole 286 located at the top of the vertical column allows it to “breathe” and maintain a dry interior. To prevent moisture from entering the joints, sealant (e.g., structural silicone glazing) can be placed in the cleft 287 prior to assembly. Similarly, throughout the structure, sealant can be placed between bolted joints, and into threaded holes.

Just as the vertical columns have small holes that allow the interior to “breathe,” the major and minor cross beams can also have small holes on the underside at each end. These small holes are not shown in the figures, but are described herein. The small holes allow water to drain that might enter the interior through welding imperfections. For example, if humid air enters the imperfection during a warm day, the moisture could condense during a cold night. If liquid water were to accumulate within the cross beams, rusting could occur. Furthermore, if the interior water were to freeze, it would expand and could damage the structure. Placing a hole at the low end in the cross beam allows accumulated water to drain. Placing a hole at the high end allows air to circulate through natural convection when the beam is heated during the day, and thereby keeps the interior dry.

To support the connection load, the threaded plates are thick thus ensuring enough bolt threads are engaged. Because the column is not penetrated by threaded holes, the walls can be thin, which reduces weight, saves material expense, and eases installation. If bolt holes were placed directly in the column, it would create another entry point for water to enter the column and thereby cause rust. If the rust is too severe, over time, the joint can fail and cause the structure to collapse.

FIG. 5b shows an embodiment in which the welded angle t has slots 312 rather than holes, which gives flexibility during assembly.

FIG. 5c shows an embodiment in which the welded angle 310 is held in place by a bolted clamp 298 rather than bolted holes or slots, which gives even greater flexibility during assembly.

FIG. 5d shows an embodiment in which the vertical column 52a is too small to have a cleft. Instead, a U-shaped clamp 320 is located at the top of the column 52a. The major cross beam fits into the U-shaped clamp 320. A threaded plate is welded to the major cross beam. The holes 321 in the U-shaped clamp 320 align with the threaded holes 331 in the welded plate 330, which allows bolts to secure the joint.

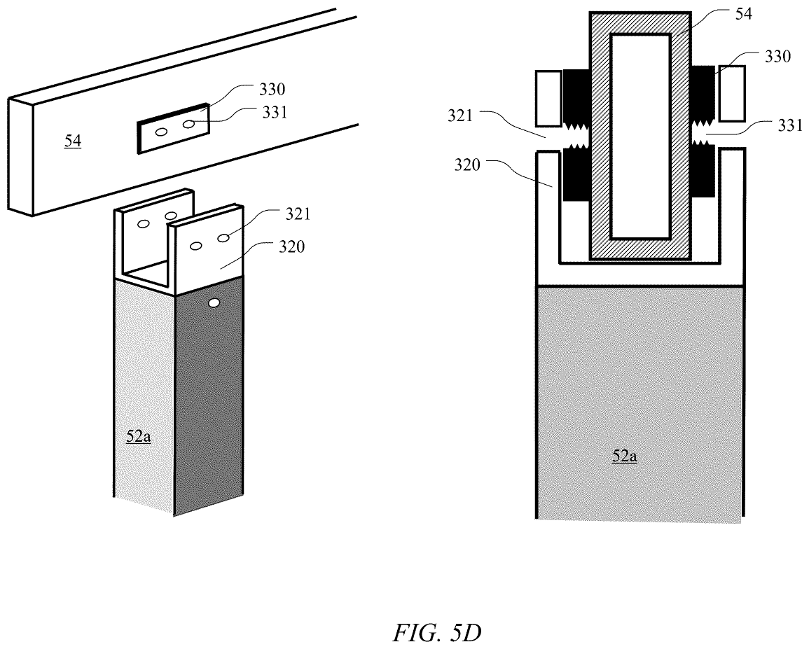

FIG. 6 shows the major cross beam 64 has a welded threaded plate 351. An angle joint 370 is welded to the minor cross beam 65. The holes 371 in the angle joint 370 align with the threaded holes 351 in the welded plate 350, thus allowing bolts to secure the joint. The angle joint can be manufactured with a variety of angles that provide easy customization so the solar panels have the desired angle with respect to the sun.

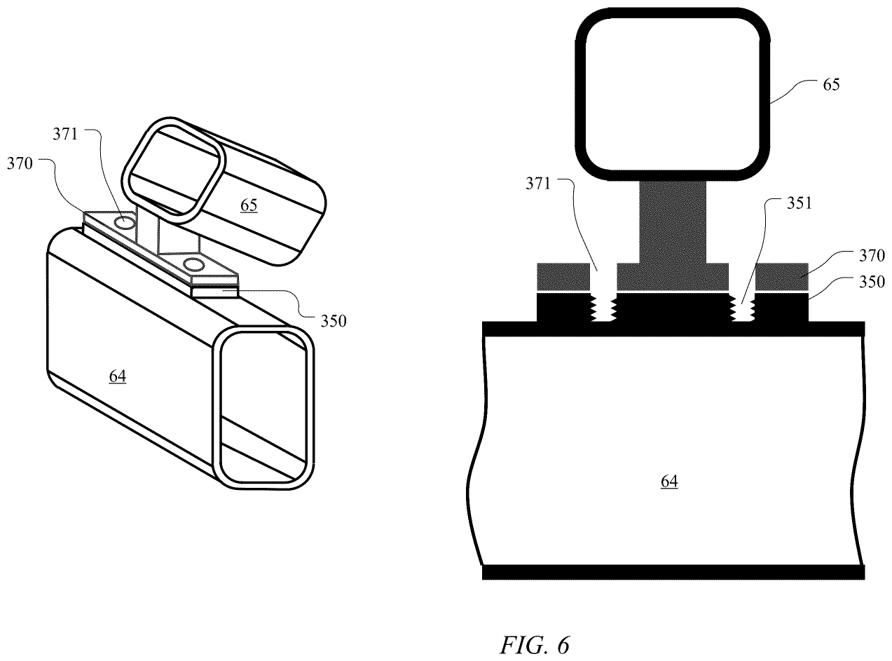

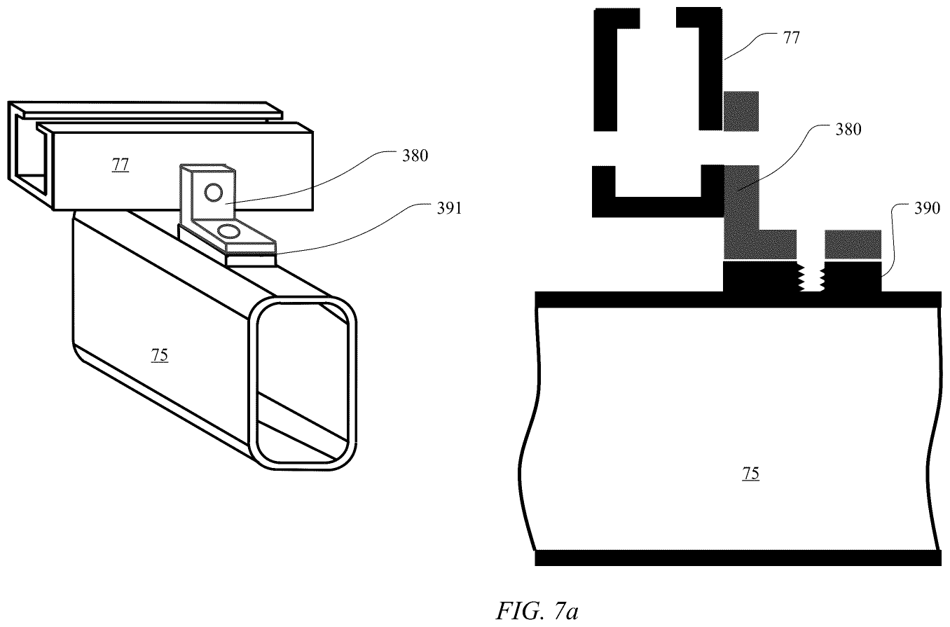

FIG. 7a shows the right-angle joint 380 that connects the standard solar panel rails 77 to the minor cross beams 75. In this embodiment, a bolt connects the right-angle joint 380 to the rail 77 and another bolt connects to a welded threaded plate 390 on the minor cross beam 75.

FIG. 7b is an embodiment similar to FIG. 7a, except the right-angled joint 380a is welded directly to the minor cross beam.

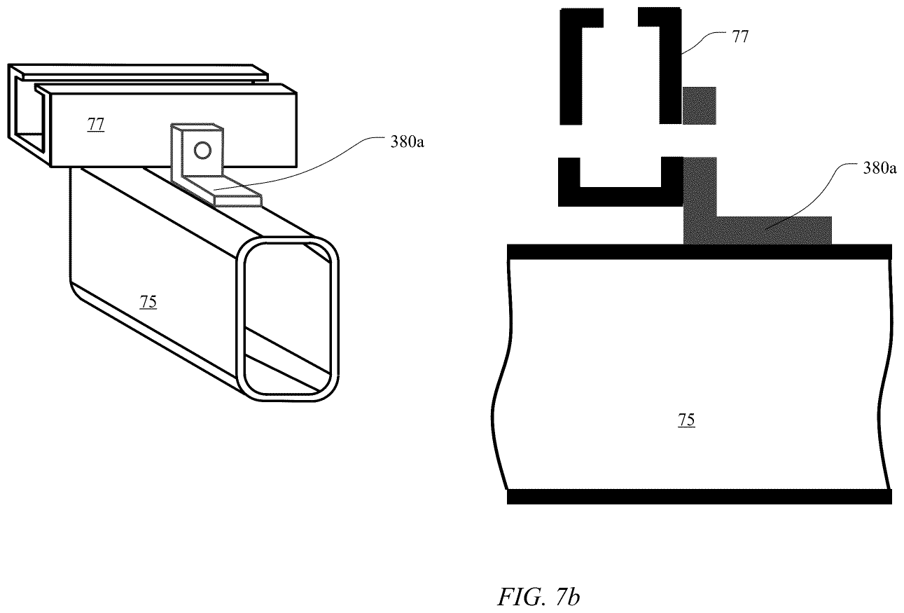

FIG. 8 shows a top view of the pergola 80 in which the major cross beams 84a, 84b, 84c are spliced together at the joints atop the vertical columns 82a, 82b.

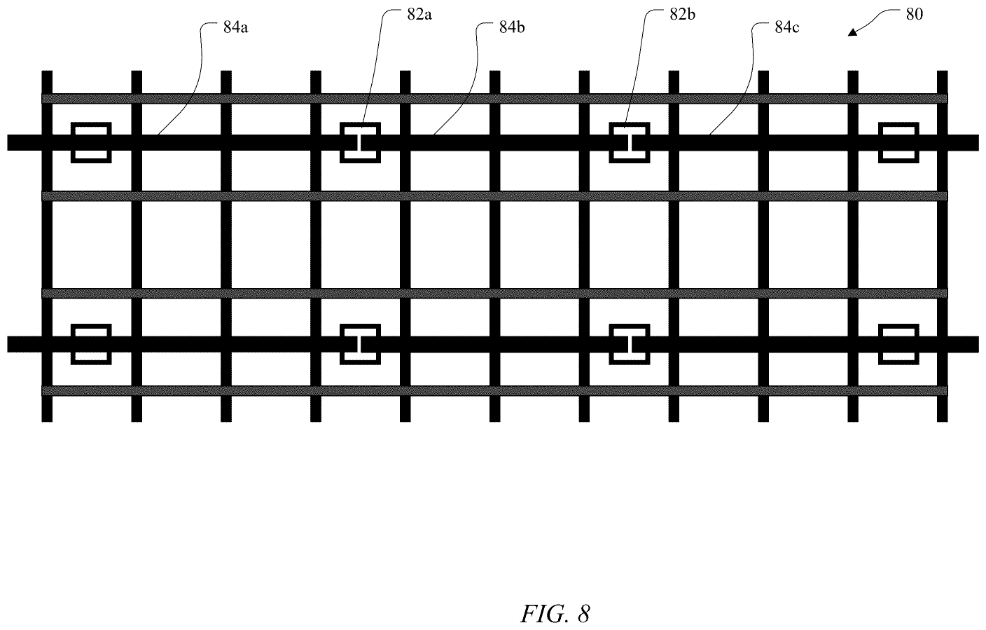

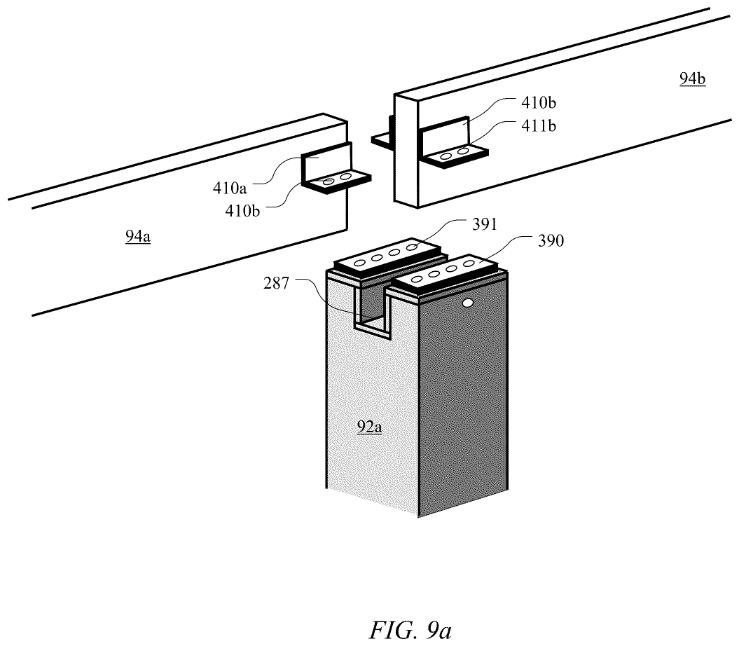

FIGS. 9a and 9b show two configurations of splicing together cross beams 94a, 94b, according to embodiment of the disclosure.

FIG. 9a is similar to FIG. 5a except that the welded plate 390 with threaded holes 391 interfaces with welded angels 410a, 410b on different cross beams 94a, 94b. As shown in FIG. 9a, when compared to FIG. 5a, the welded plate 390 has been increased from two to four holes and the welded angles 410a, 410b have been moved to an edge of the cross beams 94a, 94b.

FIG. 9b is similar to FIG. 5d except that the U-shaped clamp 420 with holes 421 interfaces with welded plates 430a, 430b, with threaded holes 431a, 431b welded angels 410a, on different cross beams 94a, 94b. As shown in FIG. 9b, when compared to FIG. 5d, the U-shaped clamp 420 has been increased from two to four holes and the welded plates 430a, 430b have been moved to an edge of the cross beams 94a, 94b.

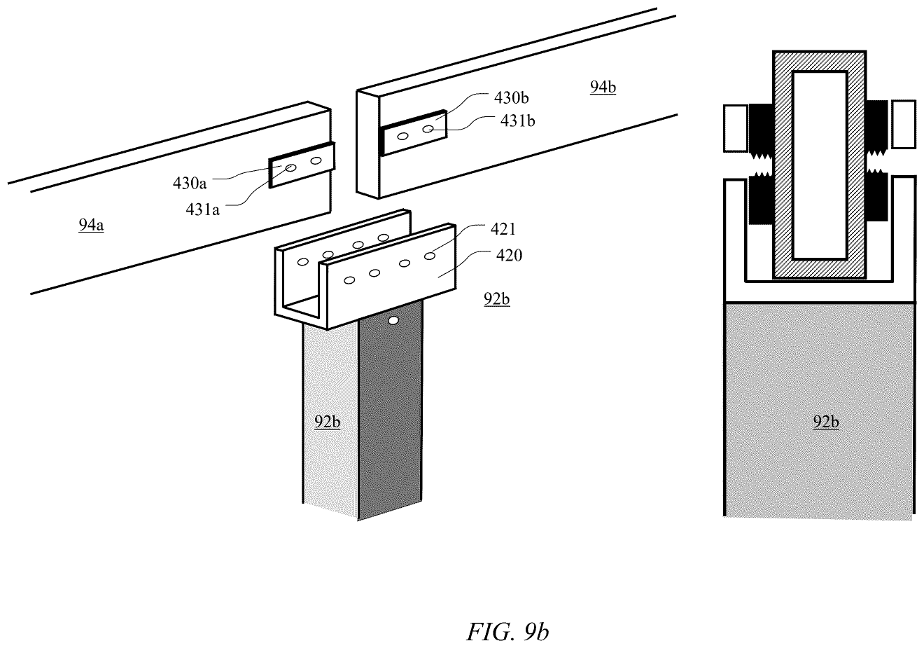

FIG. 10 shows that hollow beams can contain wiring systems. To service each solar panel, an electrical jack plug 453 can be installed into the wall of the beam. The electrical jack plug allows the solar panel to be conveniently connected when installed, and disconnected when its service life has ended. The wiring harnesses are inside the hollow beams, which provides electrical safety and prevents the wires from being stolen by thieves. To prevent water from entering the hollow beams, panel-mounted jack plugs can be employed with appropriate gaskets and sealants to ensure water does not enter the beam. As mentioned previously, the beams can “breathe,” so if some water evades the seal, it will not accumulate within the beam.

### Covered Parking

The large pergola shown in FIG. 8 could be used for covered parking; however, the vertical columns make it difficult for the vehicle to maneuver when entering and exiting.

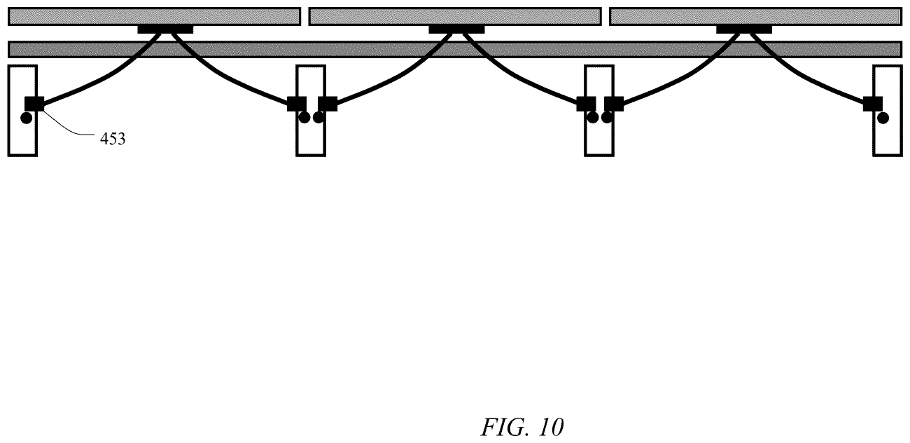

FIG. 11 shows an alternative embodiment where the support columns 112a, 112b, are moved towards the center. The joints with the foundation 113a, 113b could be rigid, such as the examples shown in FIGS. 3a and 3b. Similarly, the joints with the major cross beams 114 could be rigid, such as the examples shown in FIGS. 5a to 5d. The disadvantage of rigid joints is that a great deal of manufacturing precision is required, which adds cost. If there are small errors, rigid structures will have stress concentrations that could make the structure fail.

To overcome the potential problem described above, the connections at each end of the support columns can rotate using a clevis fastener system 481a, 481b, 483a, 483b. Despite dimensional imperfections in the manufacture, the structure can adjust and ensure there are no stress concentrations at the joints that could lead to failures. Furthermore, the angle of the solar panels relative to the sun is easily specified by adjusting the relative lengths of each support column. Optionally, a hydraulic or screw jack could be installed between the support column and a clevis. By extending or shrinking the jack, it is possible to change the angle of the panels seasonally or daily, which allows for a more optimal angle and greater solar energy collection.

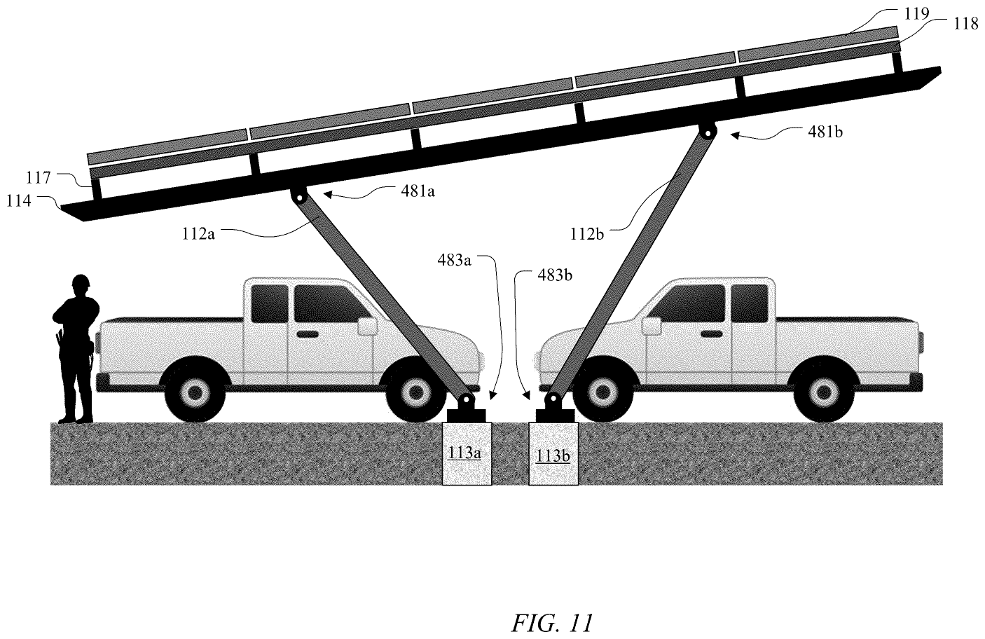

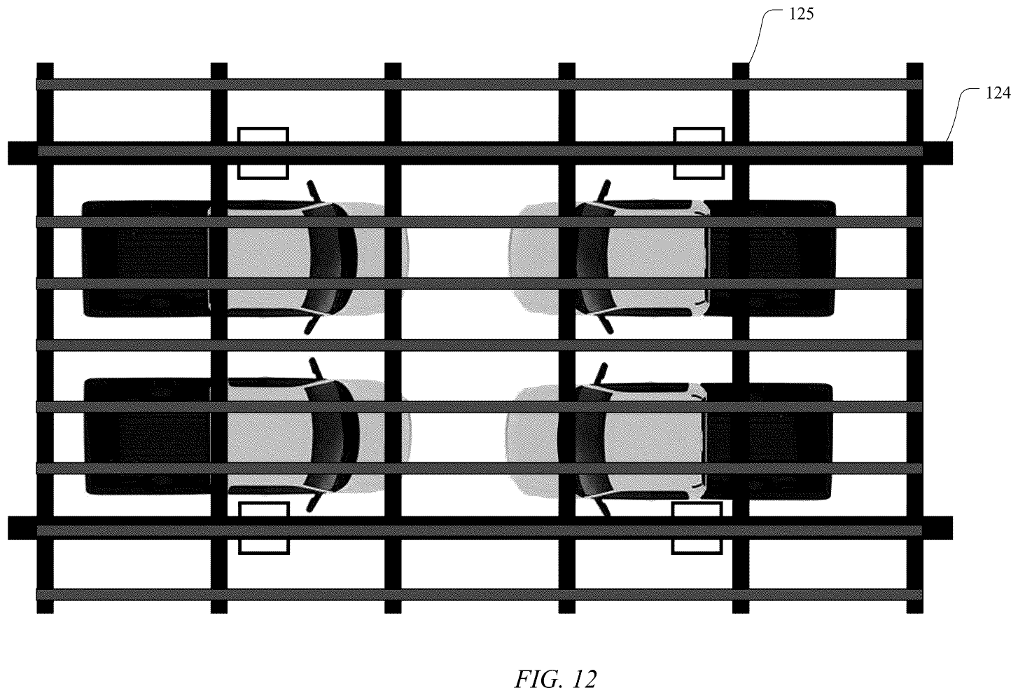

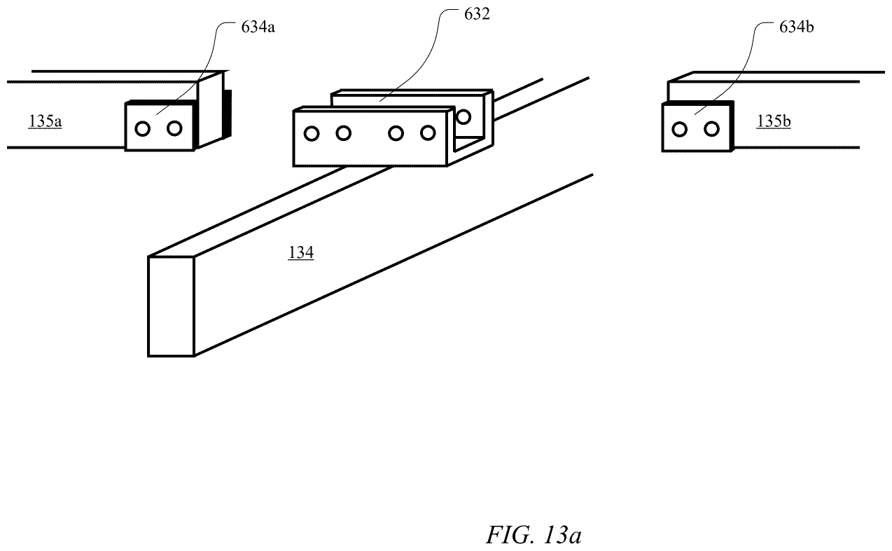

FIG. 12 shows an overhead view of the covered parking system. The connection between the support columns and the major cross beams 124 is indicated as an open box. The minor cross beams 125 can connect to the major cross beams 124 using the U-shaped clamp shown in FIG. 13a or the U-shaped plate shown in FIG. 13b. In both cases, during the assembly process, the U-shaped joint safely supports the minor cross beam 125 until the bolts are installed.

FIG. 13a shows the connection the connection of minor cross beams 135a, 135b to a major cross beam 134 using U-shaped clamp 632 and weld plates 634a, 634b. The U-shaped clamp 632 may operate in a similar fashion to the connection described with reference to FIG. 9b.

FIG. 13a shows the connection the connection of minor cross beams 135a, 135b to a major cross beam 134 using U-shaped pieces 636a, 636b and weld plates 637a, 637b. As shown, the U-shaped pieces 636a, 636b have grooved portions 638 that receive the tip of the minor cross beams 135a, 135b to support the minor cross beams 135a, 135b prior to bolting. The weld plates 637a, 637b are positioned just off the end of minor cross beams 135a, 135b to allow receipt in the grooved portions.

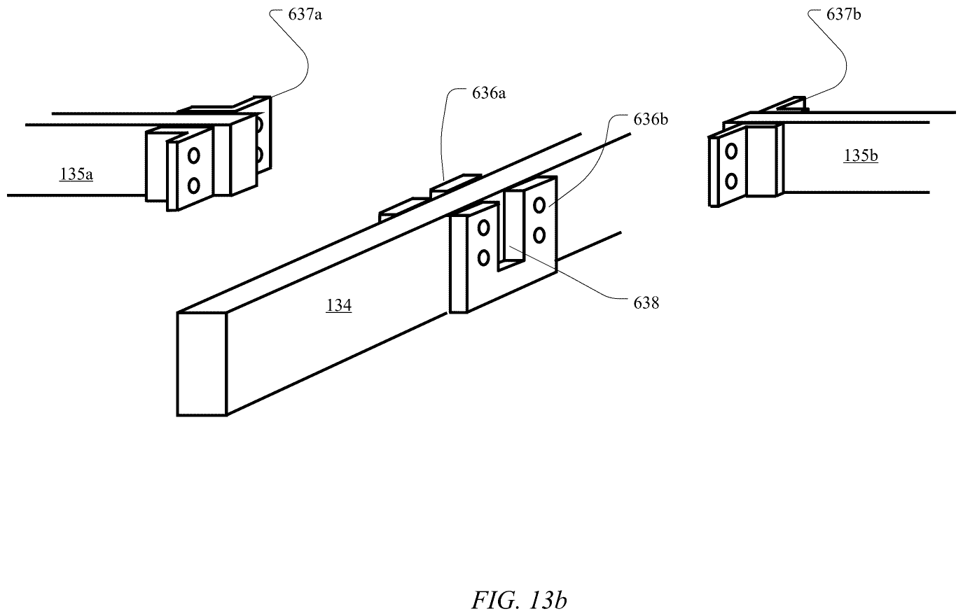

FIG. 14 shows pre-assembled structures that can be brought to the job site, which minimizes time for field erection and thereby reduces installation costs. The pre-assembled structures can have pre-installed solar panels and wiring. The connections between the standard solar panel rails can be made using a splice, which is available commercially for a given rail system.

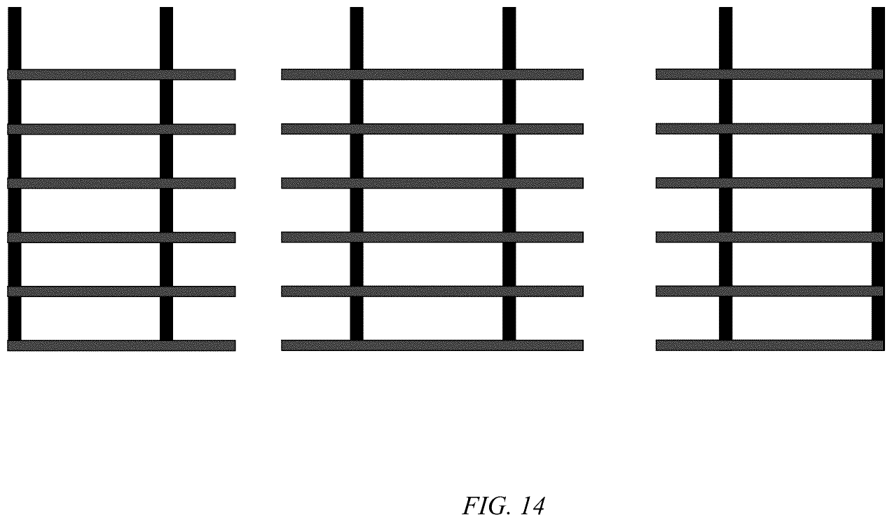

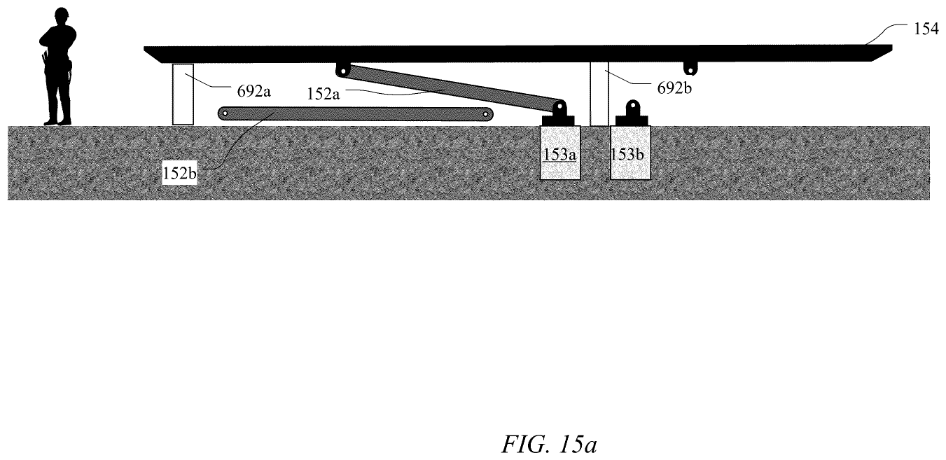

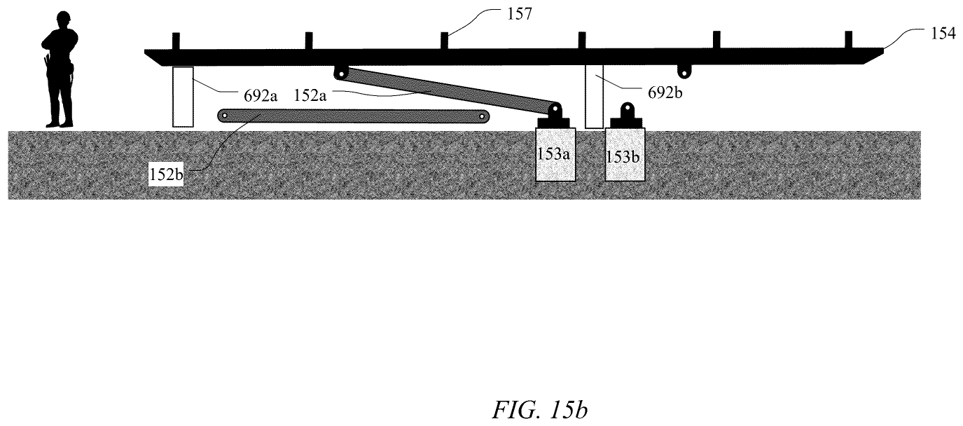

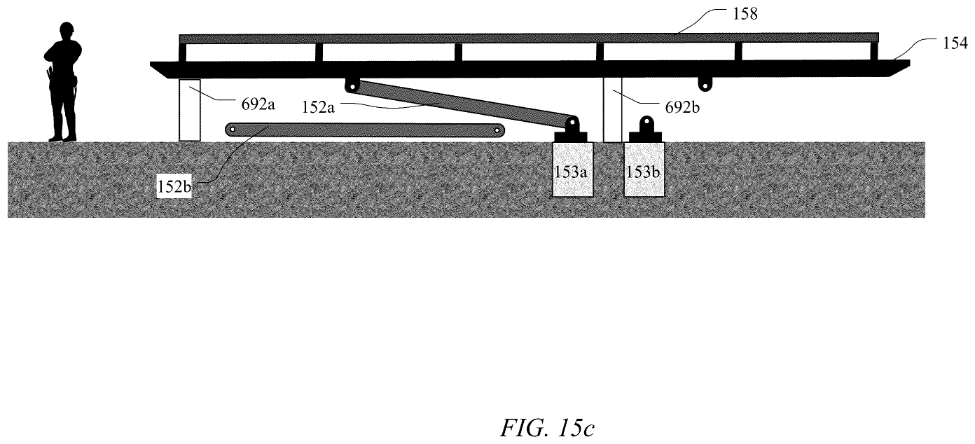

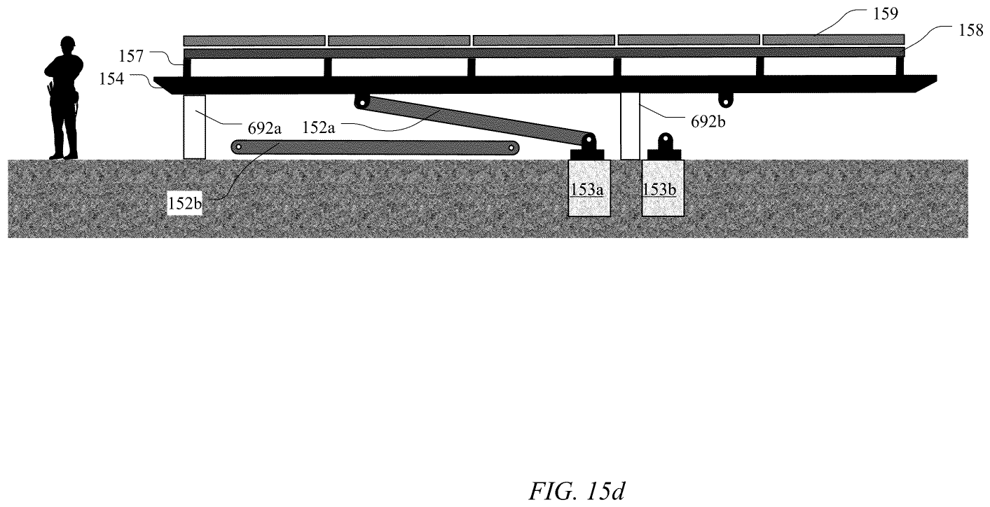

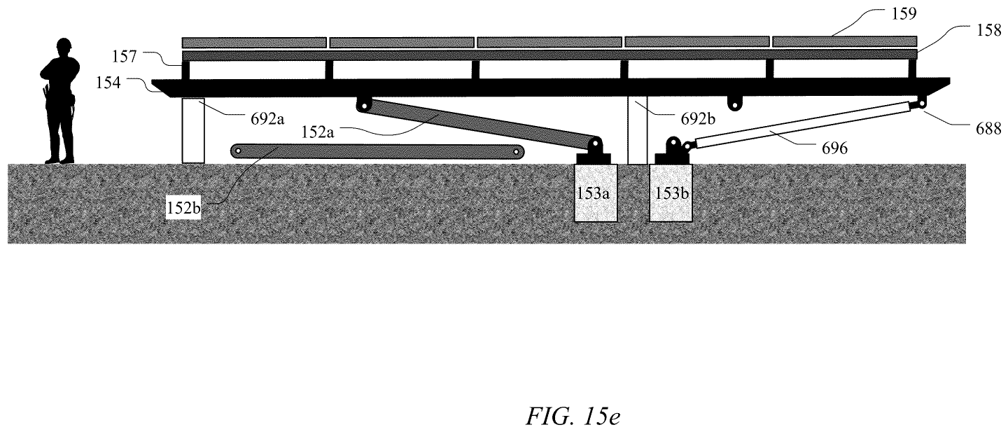

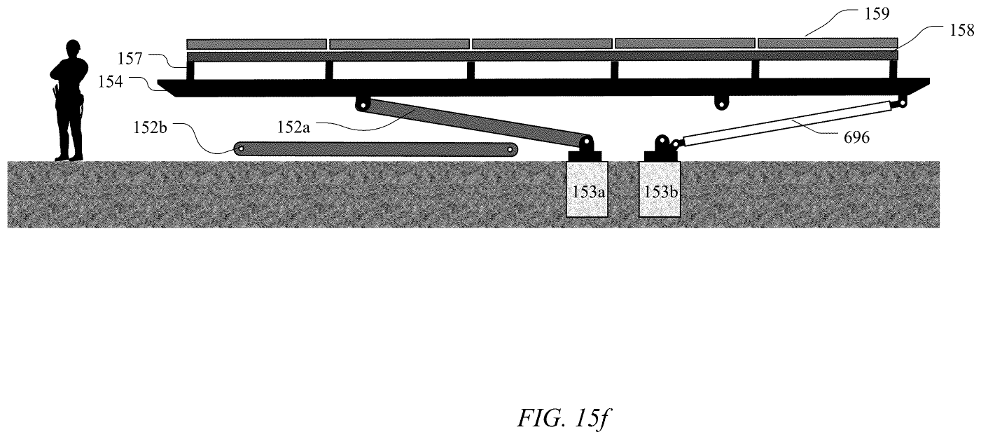

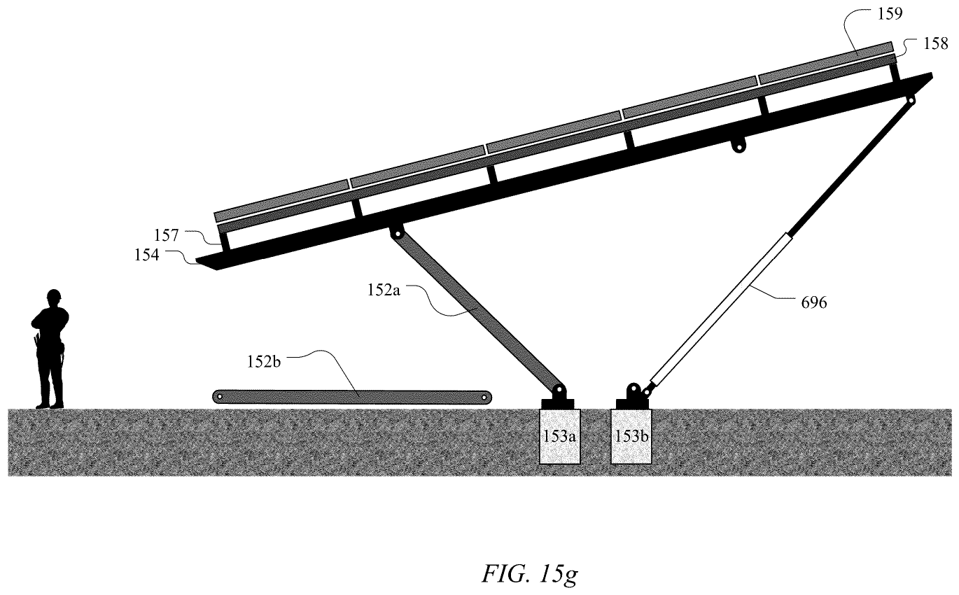

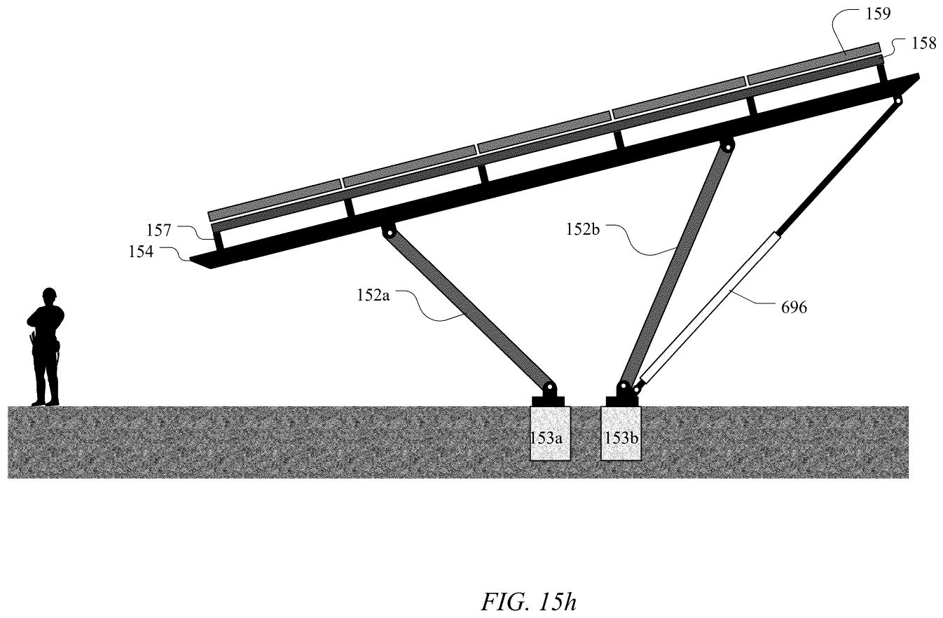

FIGS. 15a to 15i show a series of steps describing the installation process. As shown in FIG. 15a, the major cross beam 154 is supported by a temporary removable structure 692a, 692b, such as a sawhorse. The height of the temporary removable structure 692a, 692b is adjusted to make it convenient for the installation workers. Roughly, the major beam 154 should be supported at chest height. One of the support columns 152a is installed through the clevis system while the other support column 152b is waiting for installation.

FIG. 15b shows the minor cross beams 157 installed on the major cross beam 154.

FIG. 15c shows the installation of the standard solar panel rail 158.

FIG. 15d shows the solar panels 159 installed on the standard solar panel rail 158.

FIG. 15e shows a temporary jack 696 installed between the foundation 153b and the major cross beam 154. The joining system 688 is temporary, such as a removable clamp.

FIG. 15f shows the sawhorses have been removed.

FIG. 15g shows the temporary jack 696 has been extended, which raises the structure.

FIG. 15h shows the other support column 152b has been installed.

FIG. 15i shows the temporary jack 696 has been removed, which completes the installation procedure.

### Agriculture

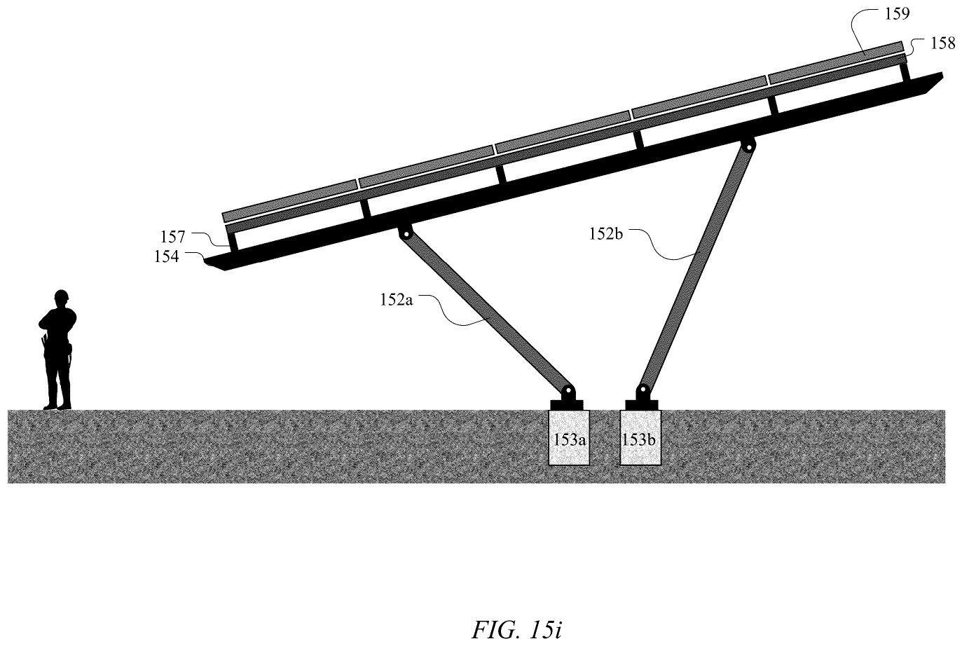

FIG. 16 shows the rate of photosynthesis as a function of light intensity. On a sunny summer day, the light intensity is about 5 times greater than is necessary because the plant photosystems are saturated. Because plants require only about 1/5 the light that falls on a sunny summer day, ⅘ of agricultural land can be covered with solar panels with negligible reduction in plant productively. Furthermore, the solar panels provide shade that reduces water loss. In desert environments, dust rapidly accumulates on the solar panels. Frequent washing with water removes the dust, and it provides water to the plants growing below the solar panels.

To ensure that light is distributed somewhat evenly below the solar panels, a variety of light dispersion devices may be utilized between the solar panels. These dispersion devices function to redirect and scatter sunlight to areas that would otherwise be shaded, enhancing overall illumination beneath the panels. One non-limiting example of a light dispersion device is a concave or convex lens installed between the solar panels that can focus and spread light over a wider area. Other non-limiting examples of light dispersion devices include surfaces with ribs, dimpled patterns, random patterns, and frosted patterns, each of which can scatter incoming light in multiple directions. Yet other non-limiting examples include any surface or structure designed to disperse incoming light, such as prismatic elements, diffusive films, holographic diffusers, micro-lens arrays, or combinations thereof. Additionally, while glass may be used in particular configurations, other materials such as plastic, acrylic, polycarbonate, or other transparent or translucent materials may also be employed. The dispersion devices can be integrated as standalone components or incorporated into existing structures of the solar panel assembly.

In certain configurations utilizing glass, the glass panels disposed beneath, adjacent to, or in proximity to the solar cells may be formed from chemically strengthened or otherwise toughened glass materials to enhance their durability, resist breakage, and withstand both environmental stressors and mechanical impacts. As one illustrative technique, the glass may undergo an ion exchange process in which it is immersed in a high-temperature salt bath—often maintained at approximately 400° C. or higher-wherein smaller ions initially present in the glass (for example, sodium ions) are replaced by larger ions (for example, potassium ions) sourced from the molten salt. This selective exchange of ions establishes a surface layer within the glass that is under compressive stress, effectively increasing the glass's strength, resistance to cracking, and longevity under a wide range of operating conditions.

Moreover, to further strengthen the glass, additional reinforcing compounds and dopants can be incorporated. By way of non-limiting example, materials such as aluminum oxide (alumina), zirconium oxide, magnesium oxide, or other suitable ceramic, metallic, or non-metallic additives may be included to refine the glass's microstructure, enhance its surface hardness, or improve its resistance to thermal shock and weathering. These additives may be introduced at various stages of the glass fabrication process, including during the initial melt, as a surface coating applied after shaping and forming, or during subsequent treatment steps specifically designed to tailor the glass's mechanical and optical properties.

It should be understood that the toughening of the glass is not limited to the ion exchange approach. Alternative methods for strengthening the glass can be employed as well, such as thermal tempering, mechanical lamination (e.g., bonding multiple layers of glass or glass with polymeric interlayers), sol-gel treatments, or other known physical and chemical hardening processes. Such methods may be selected based on the desired balance between strength enhancement, optical clarity, manufacturing complexity, and cost considerations. In some applications, hybrid or sequential processes may be implemented, combining, for instance, an initial chemical strengthening step with subsequent thermal treatment or controlled annealing protocols, to achieve a precisely tuned set of characteristics suitable for photovoltaic implementations.

Additionally, it should be recognized that various commercial forms of chemically, thermally, or otherwise toughened glass are available from multiple suppliers. By way of example only, toughened glass products are available under trade names such as Gorilla Glass™, Dragontail™, Xensation™, and others. These and similar formulations, including proprietary or custom compositions, may be readily integrated into solar module assemblies to improve their robustness and operational lifespan.

In light of the foregoing, it should be emphasized that the inventive concepts disclosed herein are not limited to any particular toughening methodology, glass composition, additive inclusion, or brand of commercially available product. Rather, all such variations, modifications, and equivalent processes that may enhance glass strength, durability, and performance in the context of dispersing light beneath solar panels are intended to be encompassed within the scope of the disclosure.

The advantages of utilizing ion-exchanged or otherwise toughened glass in the context of light-dispersing panels are numerous. For example, the treated glass can be substantially stronger than conventional glass, enabling it to resist damage better when subjected to environmental hazards such as hailstorms, wind-blown debris, or impacts from small rocks. This enhanced durability can increase the operational lifespan of the installation, reduce maintenance intervals, and minimize the need for costly replacement components.

Additionally, the toughened glass can exhibit improved surface hardness, making it more resistant to scratches and abrasions. Such scratch resistance is beneficial not only in maintaining the aesthetic appearance of the installation but also in preserving the optical qualities of the glass.

In certain configurations, this strengthening process can be achieved without significantly increasing the density or mass of the glass, allowing for the production of relatively lightweight panels. By reducing the overall weight of the glass components, shipping, handling, and installation costs may be lowered. Similarly, the ability to manufacture the glass in thinner cross-sections can decrease both the volume and cost of transportation and streamline installation logistics, allowing for more panels to be shipped and stored in a given space.

Moreover, the combination of optical clarity and minimal thickness achieved through careful material selection, chemical processes, and optional dopants or coatings can result in exceptionally transparent panels. This optical quality helps to ensure that the maximum amount of available solar light passing through the glass for dispersion.

It should be emphasized that while the above advantages highlight certain beneficial attributes, the disclosure is not limited to these features alone. Rather, any glass panels that deliver enhanced strength, hardness, reduced weight, compact thickness, and high levels of transparency—whether achieved through ion exchange, thermal tempering, additive incorporation, or other known or yet-to-be-developed techniques—may be employed. All such variations, modifications, and equivalent processes that enhance the mechanical, optical, or handling properties of the glass in service of improving light dispersion and longevity are intended to fall within the scope of this disclosure.

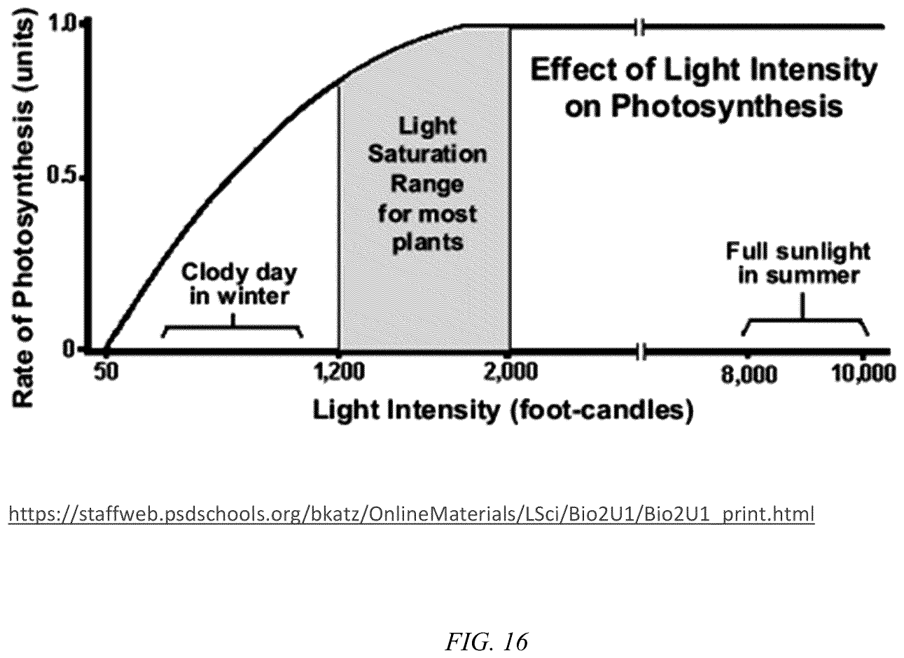

FIG. 17 illustrates light dispersion principles from which embodiments of the disclosure may benefit. More particularly, FIG. 17 illustrates how light behaves when it interacts with different types of surfaces, emphasizing both smooth and frosted material properties. The principles depicted are applicable to a variety of dispersion devices and materials.

A beam of incident light is shown approaching the surface at an angle with respect to the normal of the surface. The light that is reflected from the smooth surface at an angle equal to the incident angle (Θr=Θi) is labeled as “specularly reflected light,” following the law of reflection. A portion of the light enters the material at a different angle (Θt) due to a change in medium, illustrating the phenomenon of refraction as governed by Snell's Law. Some of the light energy is absorbed by the material, indicated by arrows pointing into the material without exiting. Below the smooth surface, a frosted (rough) surface is depicted. The refracted light that interacts with this frosted surface is scattered in multiple directions because of diffuse reflection and transmission. The light that exits the frosted surface after scattering is shown spreading out in various directions, labeled as “diffusely transmitted light.” This diffused transmission enhances the distribution of light beneath the solar panels.

The frosted effect can be achieved through various surface treatments and manufacturing processes. Frosting is accomplished by grit blasting, abrasive brushing, acid etching, sandblasting, or applying chemical treatments to roughen the glass surface. These methods are inexpensive and commonly available. Moreover, it is fairly easy to control the amount of diffusion based on the intensity and technique of the frosting process. Different levels of surface roughness can be engineered to achieve desired light diffusion characteristics.

It is also possible to apply a film or coating to regular glass or other transparent materials to create a frosted or diffusive effect. Lightly frosted glass using films or coatings can transmit up to 90% of the light, which is comparable to regular clear glass. Acid-etched frosted glass transmits approximately 80 to 83% of light. These films or coatings can be made from materials such as polyethylene terephthalate (PET), polyvinyl chloride (PVC), or other suitable polymers. They can be applied as laminates, sprays, or adhesives, providing flexibility in manufacturing and installation.

While select techniques are provided, a variety of patterned materials—including but not limited to glasses, plastics, acrylics, or other transparent substrates—will diffuse the light. Patterned surfaces can include geometric patterns, microstructures, nanostructures, or random textures designed to scatter light efficiently. Such patterns can be fabricated through processes like casting, extrusion, rolling, grit blasting, embossing, injection molding, lithography, or 3D printing. The selection of the dispersion device can be tailored based on factors such as cost, durability, optical efficiency, and aesthetic considerations.

Various formed shapes can be utilized to achieve desired light dispersion characteristics between the solar panels. Non-limiting examples of such formed shapes include Fresnel lenses, flutes, ribs, random patterns, dimples, and frosted surfaces. Each of these formed shapes alters the path of incoming light in specific ways to enhance illumination beneath the solar panels.

Fresnel lenses are thin, lightweight optical lenses composed of a series of concentric annular sections or grooves. These lenses can focus or disperse light efficiently while using less material than traditional lenses. When incorporated between solar panels, Fresnel lenses can redirect sunlight to shaded areas, improving the overall distribution of light without adding significant weight or thickness to the structure.

Flutes or ribs refer to elongated grooves or channels formed on the surface of a material. These grooves can be linear, curved, or arranged in specific patterns to control the direction and diffusion of light. Fluted or ribbed surfaces can scatter light laterally, distributing it over a wider area beneath the solar panels. The dimensions and orientations of the flutes or ribs can be engineered to achieve desired light dispersion effects.

Random patterns involve irregular or non-uniform surface textures that scatter incoming light in multiple directions. These patterns can be created through manufacturing processes such as chemical etching, mechanical abrasion, laser engraving, rolling, or molding techniques. The randomness of the pattern ensures that light is diffused unpredictably, reducing hotspots and providing a more uniform illumination beneath the panels.

Dimples are small, concave or convex indentations formed on the surface of a material, similar to those found on a golf ball. The curved surfaces of the dimples cause incoming light to scatter in various directions due to diffraction and reflection phenomena. Dimpled surfaces can enhance light diffusion while maintaining structural integrity and aesthetic appeal.

Frosted surfaces are created by roughening the surface of a transparent material, as previously described. Frosting scatters light passing through the material, reducing glare and softening the transmitted light. Frosted surfaces can be achieved through techniques such as grit blasting, acid etching, sandblasting, or applying frosted films. The level of light diffusion can be controlled by adjusting the degree of surface roughness or the properties of the applied film.

These formed shapes can be implemented individually or in combination to tailor the light dispersion characteristics to specific needs. They can be fabricated using a variety of materials, including glass, plastic, acrylic, polycarbonate, or other suitable transparent or translucent substrates. The selection of material and formed shape can be optimized based on factors such as optical efficiency, durability, cost, weight, and ease of manufacturing.

In addition to the aforementioned examples, other formed shapes and surface treatments can be employed to achieve desired light diffusion effects. For instance, prismatic patterns consist of small triangular facets that refract light at specific angles, directing it to targeted areas. Micro-lens arrays feature numerous tiny lenses molded onto a surface, which can focus or diffuse light depending on their configuration. Holographic diffusers use diffraction gratings to scatter light uniformly across a surface, creating even illumination.

In addition to surface treatments and patterns, volumetric diffusers can be employed, where scattering particles are embedded within the material to diffuse light throughout its volume. Materials such as translucent polymers with embedded nanoparticles, opal glass, or other diffusive composites can be utilized. These volumetric diffusers can offer uniform light dispersion and can be customized in terms of scattering properties by adjusting the concentration and type of embedded particles.

The dispersion devices may also incorporate active elements, such as liquid crystal layers or electrochromic materials, which can adjust their diffusive properties in response to electrical stimuli. This allows for dynamic control of light dispersion, enabling the system to adapt to varying environmental conditions or user preferences.

The dispersion devices can be integrated into the solar panel assembly in various configurations. For instance, they can be positioned between individual solar panels, attached to the underside of the panels, or incorporated into the mounting structure. They can also be designed to serve multiple functions, such as providing structural support, weather protection, or aesthetic enhancement in addition to light dispersion.

The materials used for dispersion devices can also be selected based on environmental considerations. For example, materials with high durability, UV resistance, and low thermal expansion coefficients can be chosen to withstand outdoor conditions. Recyclable or biodegradable materials can be employed to reduce environmental impact.

It should be understood that the light dispersion devices are not limited to the examples provided herein. Any device, structure, or material capable of scattering, diffusing, refracting, or otherwise redistributing light can be utilized within the scope of this disclosure. The dispersion devices can be customized to meet specific requirements of different applications, environments, or installation conditions.

As a non-limiting example, the light dispersion device may receive from a non-planar surface (e.g., a domed or curved surface) that can capture incident light for ultimate diffusion.

While agriculture may particularly avail from the described diffusers, the application of these formed shapes contributes to improved functionality and user experience in various settings, including but not limited to solar canopies, carports, agricultural installations, greenhouses, and building-integrated photovoltaics. By enhancing the distribution of natural light beneath the solar panels, these formed shapes can reduce the need for artificial lighting, promote plant growth, or create more comfortable and aesthetically pleasing environments.

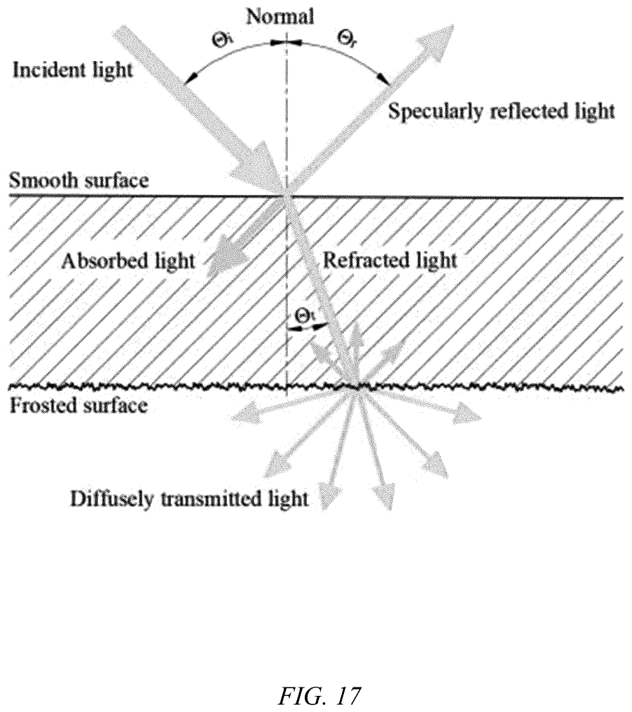

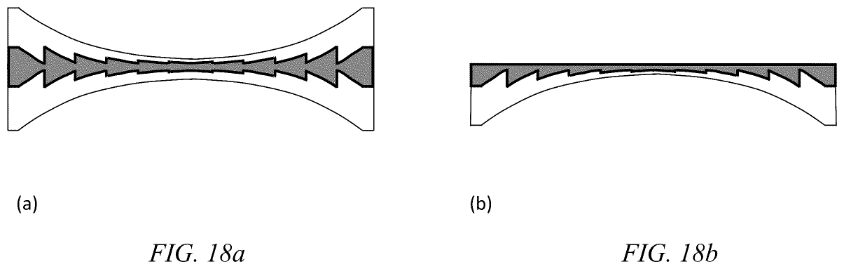

FIGS. 18a and 18b shows two examples of concave lens. FIG. 18a has a concave shape on both surfaces, and FIG. 18b has a concave shape on one surface. To reduce mass, both approaches employ Fresnel lens. The Fresnel lens extend in the linear direction and could be manufactured by extrusion or casting. (Note: Although concave examples are shown, the focusing surface could be convex as well.)

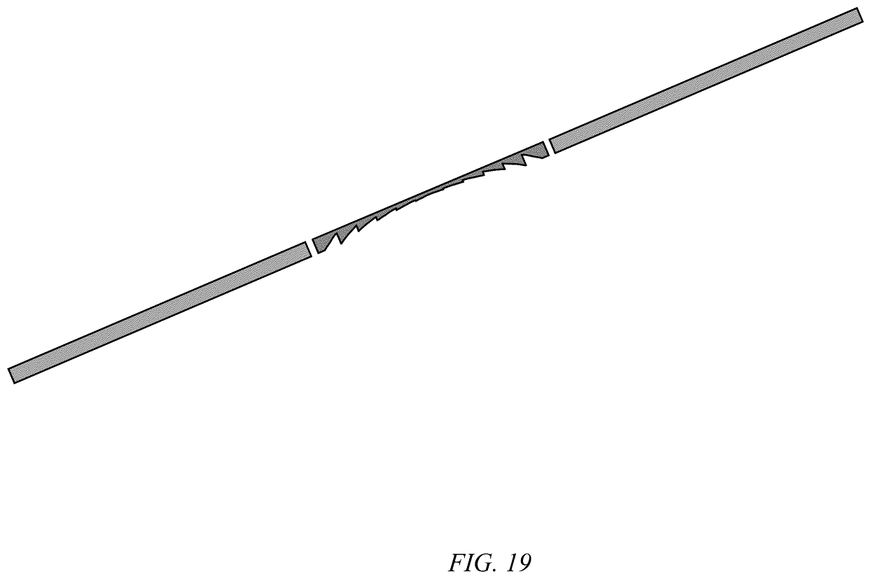

FIG. 19 shows a concave Fresnel lens installed between the panels. (Alternatively, a convex Fresnel lens could be employed.) Roughly ⅕ of the surface area is Fresnel lens and ⅘ is solar panels. If semi-transparent solar panels are employed, the ratio can be adjusted accordingly.

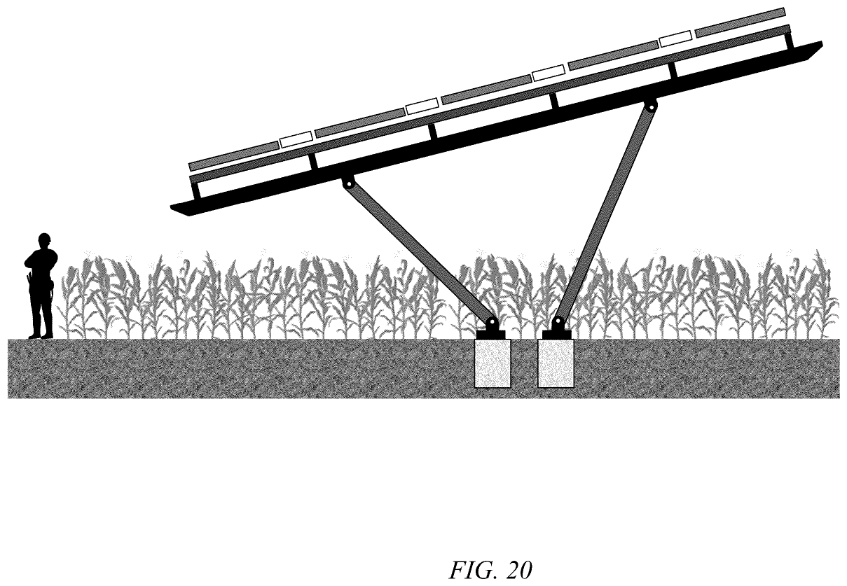

FIG. 20 shows the solar panels and concave Fresnel lens installed on the support structure. Gaps between the solar panels and Fresnel lens allow rainwater or wash water to fall onto the plants below.

Although this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A light dispersion device for use with a solar panel assembly, the light dispersion device comprising:
a transparent or translucent material having a surface configured with a light-diffusing pattern,
wherein the light-diffusing pattern is adapted to scatter and redistribute incoming sunlight to enhance illumination beneath the solar panel assembly, and
wherein the light dispersion device is positioned between individual solar panels or attached to the underside of the solar panels.

2. The light dispersion device of claim 1, wherein the light-diffusing pattern comprises a Fresnel lens formed on the surface of the transparent or translucent material.

3. The light dispersion device of claim 1, wherein the light-diffusing pattern comprises flutes or ribs formed on the surface of the transparent or translucent material, the flutes or ribs being configured to scatter light laterally.

4. The light dispersion device of claim 1, wherein the transparent or translucent material comprises ion-exchange toughened glass.

5. The light dispersion device of claim 1, wherein the transparent or translucent material is selected from a group consisting of glass, plastic, acrylic, and polycarbonate.

6. A light dispersion device for use with a solar panel assembly, the light dispersion device comprising:
a transparent or translucent material having a surface configured to disperse incoming sunlight, wherein
the surface includes one or more light-diffusing patterns that scatter sunlight to enhance illumination in areas below the solar panel assembly, and
the transparent or translucent material comprises ion-exchange toughened glass.

7. The light dispersion device of claim 6, wherein the light-diffusing pattern comprises a Fresnel lens formed on the surface of the transparent or translucent material.

8. The light dispersion device of claim 6, wherein the light-diffusing pattern comprises flutes or ribs formed on the surface of the transparent or translucent material, the flutes or ribs being configured to scatter light laterally.

9. The light dispersion device of claim 6, wherein the light-diffusing pattern comprises random surface textures that scatter incoming light in multiple directions.

10. The light dispersion device of claim 6, wherein the light-diffusing pattern comprises dimples formed on the surface of the transparent or translucent material, the dimples being configured to scatter light by diffraction and reflection.

11. The light dispersion device of claim 6, wherein the light-diffusing pattern comprises a frosted pattern formed on the surface of the transparent or translucent material.

12. The light dispersion device of claim 11, wherein the frosted pattern is formed by grit blasting the surface of the transparent or translucent material.

13. The light dispersion device of claim 6, wherein the light-diffusing patterns are formed by casting the transparent or translucent material.

14. The light dispersion device of claim 6, wherein the light-diffusing patterns are formed by extrusion of the transparent or translucent material.

15. The light dispersion device of claim 6, wherein the light-diffusing patterns are formed by rolling the transparent or translucent material.

16. The light dispersion device of claim 6, wherein the glass is further strengthened by incorporating one or more reinforcing additives selected from a group consisting of aluminum oxide, zirconium oxide, and magnesium oxide, the reinforcing additives being introduced during or after the ion exchange process to enhance the glass's structural integrity, scratch resistance, or resistance to mechanical impacts.

17. The light dispersion device of claim 6, wherein the light dispersion device is integrated as a standalone component or incorporated into an existing structure of the solar panel assembly.

18. The light dispersion device of claim 6, wherein the light dispersion device further comprises a concave or convex lens for focusing and spreading light over a wider area.

19. The light dispersion device of claim 6, wherein the light-diffusing pattern is configured to enhance light dispersion beneath the solar panel assembly for reducing shaded areas and promoting uniform illumination.

20. The light dispersion device of claim 1, wherein the light-diffusing pattern is achieved by applying a diffusive film or coating to the surface of the transparent or translucent material.
